(19) United States
(12) Patent Application Publication
(10) Pub. No.: US 2013/0055073 A1
(43) Pub. Date: Feb. 28, 2013

(54) APPARATUS CAPABLE OF PROVIDING PAGE RECOMMENDATION AND PAGE RECOMMENDATION METHOD

(71) Applicants: Xiaomeng Yan, Tianjin (CN); Cheng-Hung Ko, Taipei City (TW)

(72) Inventors: Xiaomeng Yan, Tianjin (CN); Cheng-Hung Ko, Taipei City (TW)

(73) Assignee: MEDIATEK SINGAPORE PTE. LTD.

(21) Appl. No.: 13/288,633

(22) Filed: Nov. 3, 2011

(30) Foreign Application Priority Data
Aug. 29, 2011 (CN) 201110250071.3

(51) Int. Cl. G06F 17/00

(52) U.S. Cl. 715/244

(57) ABSTRACT

The invention provides an apparatus capable of providing page recommendation. In one embodiment, the apparatus is coupled to a screen capable of showing a plurality of pages, and comprises a determination module, a classification module, and a displaying module. The determination module determines whether a current page displayed on the screen has enough space for containing a target item to be added to the current page. The classification module classifies the pages into available pages having enough space for the target item and unavailable pages having no enough space for the target item. The displaying module displays a page selector indicating the available pages and the unavailable pages on the screen, and adds the target item to a target page selected from the available pages.

### BACKGROUND OF THE INVENTION

1. Field of the Invention

The invention relates to electronic apparatus, and more particularly to a user interface of electronic apparatus.

2. Description of the Related Art

A portable electronic apparatus, such as a personal digital assistant (PDA), a tablet, a mobile phone, a handheld computer, a palmtop, a handheld game console, or a pocket organizer, comprises a screen served as a user interface. A background region of a screen is referred to as a page, and a user can put a plurality of items on a page. The items put on the page may be images or widgets of various application programs. Ordinarily, there is a plurality of pages stored in the portable electronic apparatus. The screen of the portable electronic apparatus can only show one of the pages at one time, and a user can manually select the page currently shown on the screen from the pages.

Referring to FIG. 1, a schematic diagram of a page 100 shown on a screen of a portable electronic apparatus is shown. The region 110 contains five dots indicating five pages stored in the portable electronic apparatus, and the colored dot represents the current page 100 shown on the screen. The current page 100 contains two widgets 101 and 102. The widget 101 is a clock program, and the widget 102 is an audio player program. As shown in FIG. 1, the two widgets 101 and 102 have occupied a majority of the area of the current page 100. When the user wants to add a new widget to the current page 100, there is no enough space for containing the new widget on the current page 100. The portable electronic apparatus then cancels the operation of adding the new widget to the current page 100. The user then must change the current page into a new page having enough space for containing the new widget, and the new widget can then be added to the new page, resulting in inconvenience for the user. When the user adds the new widget to a current page with no enough space for holding the new widget, if a mechanism of the portable electronic apparatus is activated to recommend available pages having enough space for containing the new widget to the user, the user can easily select a new page where the new widget is to be added from the recommended pages, and the user's efforts for page selection can be minimized. Thus, a method for page recommendation is required.

In addition, a current page 100 shown on a screen of a portable electronic apparatus may have contained too many widgets, as shown in FIG. 1. When a user determines that the current page has no enough space for containing a new widget, if the portable electronic apparatus has a mechanism to recommend available pages having enough space for containing the new widget to the user, the user can easily select a new page where the new widget is to be added from the recommended pages, and the user's efforts for page selection can be minimized. A method for page recommendation is therefore required.

### BRIEF SUMMARY OF THE INVENTION

The invention provides an apparatus capable of providing page recommendation. In one embodiment, the apparatus is coupled to a screen capable of showing a plurality of pages, and comprises a determination module, a classification module, and a displaying module. The determination module determines whether a current page displayed on the screen has enough space for containing a new widget to be added to the current page. The classification module classifies the pages into available pages having enough space for the new widget and unavailable pages having no enough space for the new widget. The displaying module displays a page selector indicating the available pages and the unavailable pages on the screen, and adds the new widget to a target page selected from the available pages.

The invention provides an apparatus capable of providing page recommendation. In one embodiment, the apparatus is coupled to a screen capable of showing a plurality of pages, and comprises a determination module, a classification module, and a displaying module. The determination module determines whether a target widget has been moved to a predetermined region of a current page displayed on the screen. The classification module classifies the pages into available pages having enough space for the target widget and unavailable pages having no enough space for the target widget when the target widget has been moved to the predetermined region. The displaying module displays a page selector indicating the available pages and the unavailable pages on the screen, and moves the target widget to a target page selected from the available pages.

The invention provides a page recommendation method. First, a new widget to be added to a current page displayed on a screen capable of showing a plurality of pages is obtained. Whether the current page has enough space for containing the new widget is then determined. The pages are then classified into available pages having enough space for the new widget and unavailable pages having no enough space for the new widget. A page selector indicating the available pages and the unavailable pages is then displayed on the screen. Finally, the new widget is added to a target page selected from the available pages.

The invention provides a page recommendation method. First, whether a target widget has been moved to a predetermined region of a current page displayed on a screen is determined, wherein the screen is capable of showing a plurality of pages. When the target widget has been moved to the predetermined region, the pages are classified into available pages having enough space for the target widget and unavailable pages having no enough space for the target widget. A page selector indicating the available pages and the unavailable pages is then displayed on the screen. The target widget is then moved to the target page selected from the available pages.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a page shown on a screen of a portable electronic apparatus;

FIG. 2A is a block diagram of a portable electronic apparatus according to the invention;

FIG. 2B is a flowchart of a method for adding a new widget of an application program to a page of the screen according to the invention;

FIG. 2C is a block diagram of a processor of a portable electronic apparatus capable of page recommendation according to the invention;

FIGS. 3A-3D are schematic diagrams of a series of steps for adding a new widget of an application program to a page of a screen according to the invention;

FIGS. 4A-4C are schematic diagrams of a series of steps of adding a new icon of an application program to a program menu according to the invention;

FIG. 5A is a flowchart of a method for moving a widget of an application program from a current page to a target page according to the invention;

FIG. 5B is a block diagram of a processor of a portable electronic apparatus capable of page recommendation according to the invention;

FIGS. 6A-6D are schematic diagrams of a series of steps of moving a widget of an application program to a target page according to the invention;

FIGS. 7A, 7B, 7C, and 7D show four embodiments of the page selector with a style of a text list according to the invention;

FIGS. 8A, 8B, 8C, and 8D show four embodiments of the page selector with a style of a button list according to the invention; and

FIGS. 9A, 9B, 9C, and 9D show four embodiments of the page selector with a style of a thumbnail list according to the invention.

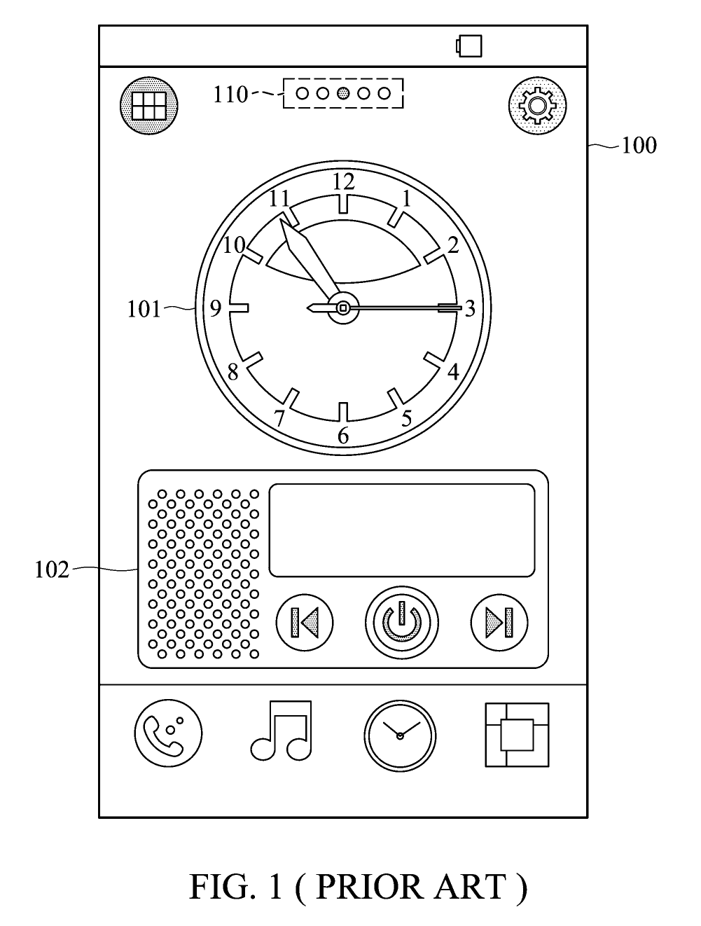

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

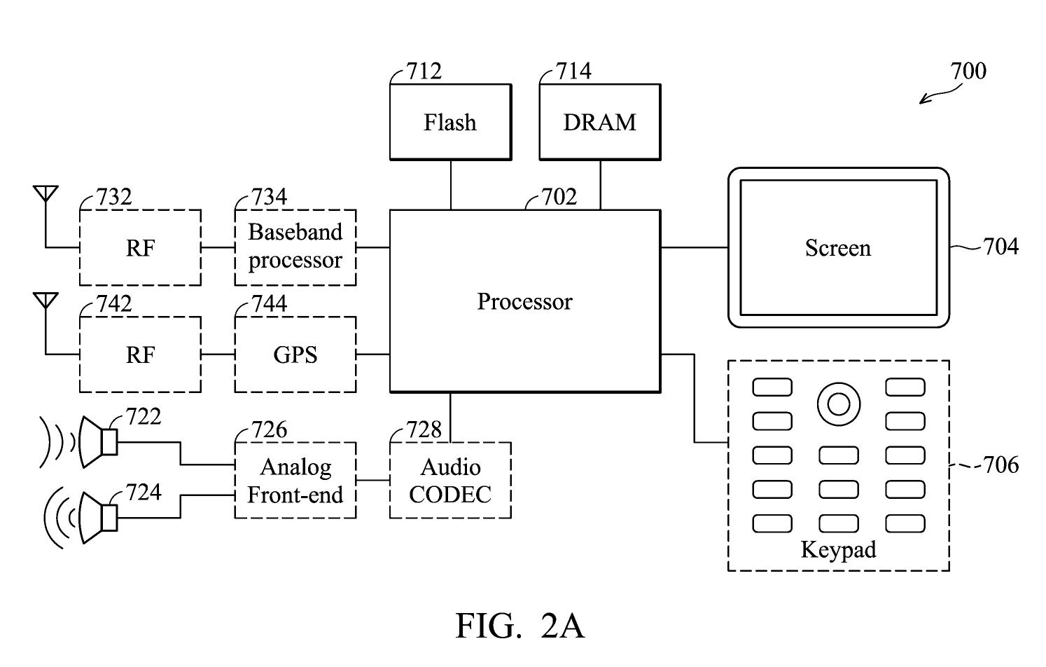

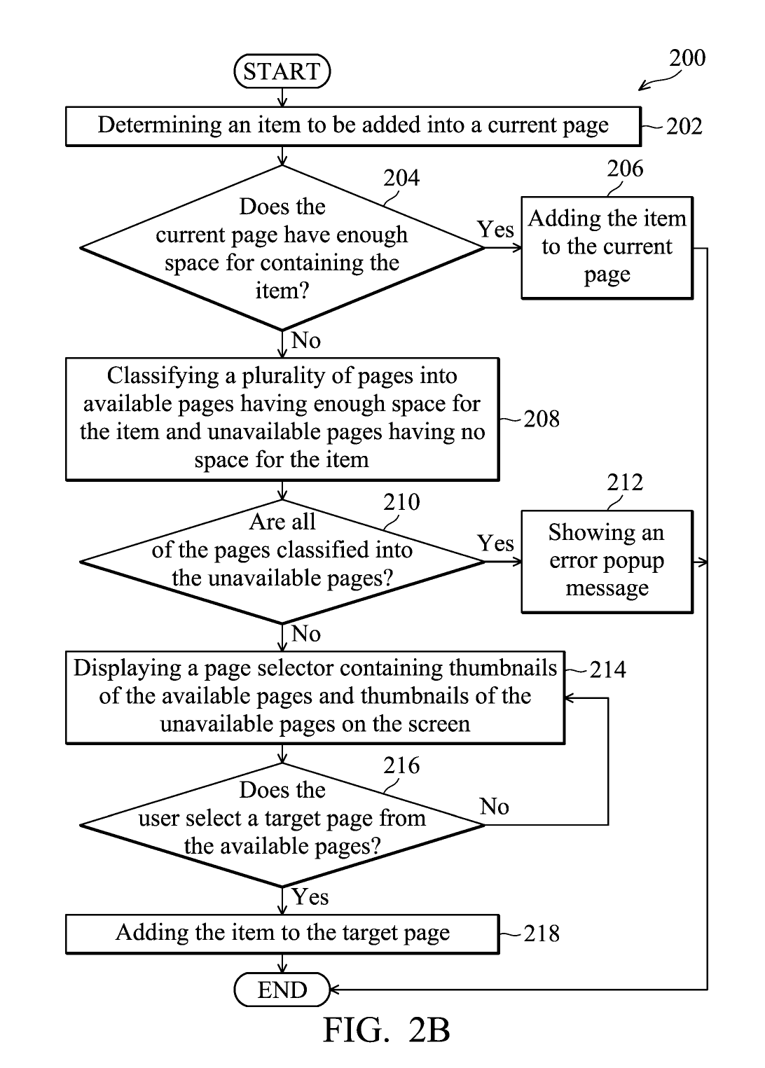

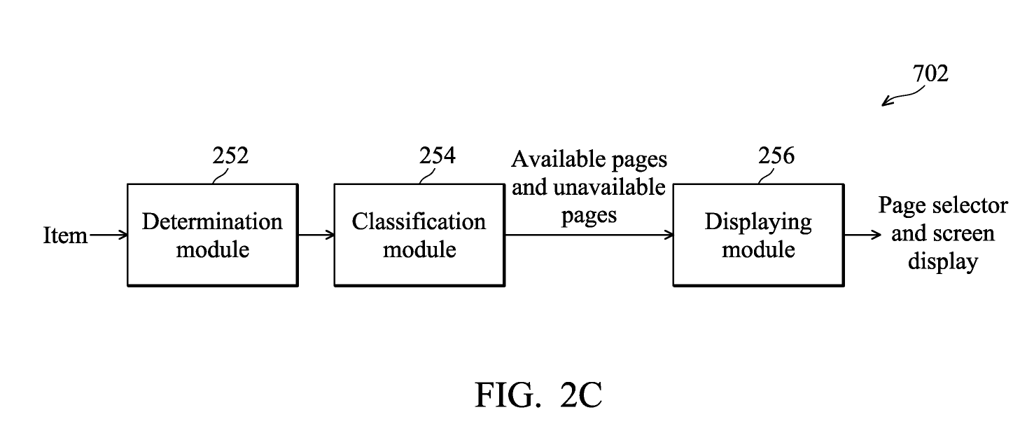

Referring to FIG. 2A, a block diagram of a portable electronic apparatus 700 according to the invention is shown. In one embodiment, the portable electronic apparatus 700 is a mobile phone, a tablet, a personal digital assistant (PDA), a handheld computer, a palmtop, a handheld game console, or a pocket organizer. The portable electronic apparatus 700 comprises a processor 702, a screen 704, a keypad 706, a flash memory 712, and a DRAM 714. The processor 702 controls other components of the portable electronic apparatus 700. The processor 702 could be a digital signal processor (DSP), a central processing unit (CPU), or other kinds of processors. The screen 704 and the keypad 706 act as an interface between a user and the portable electronic apparatus 700. A page is referred to as a background region shown on the screen 704, and a plurality of pages are stored in the portable electronic apparatus 700. The screen 704 can only show one page at one time, and the page currently shown on the screen 704 is referred to as a current page. The user can manually select a current page to be shown on the screen 704 from the pages stored in the portable electronic apparatus 700. In one embodiment, the portable electronic apparatus 700 may comprise a microphone 722, a speaker 724, an analog front-end circuit 726, and an audio CODEC 728. In one embodiment, the portable electronic apparatus 700 also comprises radio frequency circuits 732 and 742, a baseband processor 734, and a GPS circuit 744.

A plurality of application programs are stored in the portable electronic apparatus 700. When a user wants to execute an application program, the user selects a target page from the pages stored in the portable electronic apparatus 700, and places an item representing the application program on the target page. In one embodiment, the item may be a widget or an object. Thus, when the target page is shown on the screen 704, the user can interact with the application program. Referring to FIG. 2B, a flowchart of a method 200 for adding an item of an application program to a page of the screen according to the invention is shown. First, the user selects an item of an application program to be added to a current page (step 202). The processor 702 then determines whether the current page has enough space for containing the item (step 204). When the current page has enough space for containing the item, the processor 702 adds the item to the current page (step 206).

When the current page does not have enough space for containing the item (step 204), the processor 702 classifies the pages stored in the portable electronic apparatus 700 into available pages having enough space for containing the item and unavailable pages having no enough space for containing the item (step 208). In one embodiment, all pages stored in the portable electronic apparatus 700 are sequentially selected to be candidate pages, and the processor 702 determines whether the candidate pages have enough space to contain the item. When the candidate pages have enough space to contain the item, the processor 702 then determines the candidate pages to be the available pages. When the candidate pages have no enough space to contain the item, the processor 702 then determines the candidate pages to be the unavailable pages. If all of the pages are classified into the unavailable pages (step 210), the item cannot be added to any of the pages, and an error popup message is shown on the screen 704 to notify the user (step 212).

In one embodiment, after the pages are classified into available pages and unavailable pages, the processor 702 displays a page selector containing thumbnails of the available pages and thumbnails of the unavailable pages on the screen 704 (step 214). The page selector shows the thumbnails of the available pages and the thumbnails of the unavailable pages in different styles. In one embodiment, when the page selector is displayed on the screen 704, the thumbnails of the unavailable pages are filtered by a color filter, and the thumbnails of the available pages are not filtered by the color filter. The user can then easily differentiate the thumbnails of the available pages from those of the unavailable pages. After the page selector is shown on the screen 704 (step 214), the user can easily determine which page the item is added to. The user then selects a target page from the available pages according to the page selector (step 216). In one embodiment, the user selects the target page by pressing or dragging the thumbnail of the target page shown in the page selector. The processor 702 then adds the item of the application program to the target page (step 218).

Referring to FIG. 2C, a block diagram of a processor 250 of a portable electronic apparatus capable of page recommendation according to the invention is shown. In one embodiment, a chip of the processor 250 comprises a determination module 252, a classification module 254, and a displaying module 256. When the processor 250 determines that an item to be added to a current page displayed on a screen (step 202), the determination module 252 determines whether the current page has enough space for containing the item (step 204). If the current page does not have enough space, the classification module 254 then classifies a plurality of pages into available pages having enough space for the item and unavailable pages having no enough space for the item (step 208). The displaying module 256 then displays a page selector containing thumbnails of the available pages and the unavailable pages on the screen (step 214), wherein the thumbnails of the available pages and the thumbnails of the unavailable pages are displayed in different styles in the page selector. After the user selects a target page according to the page selector, the displaying module 256 then adds the item to the target page (step 218).

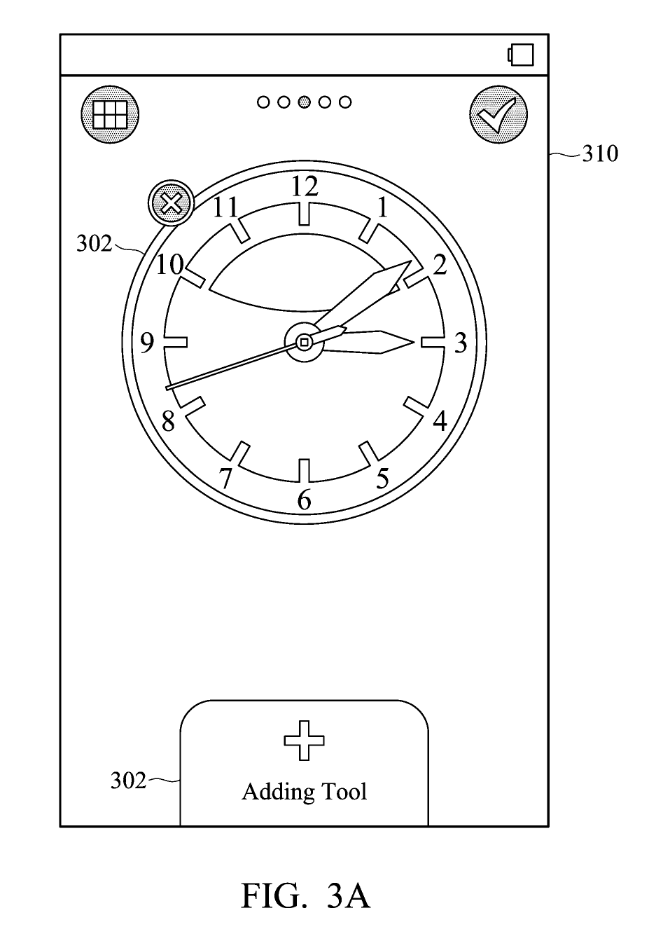

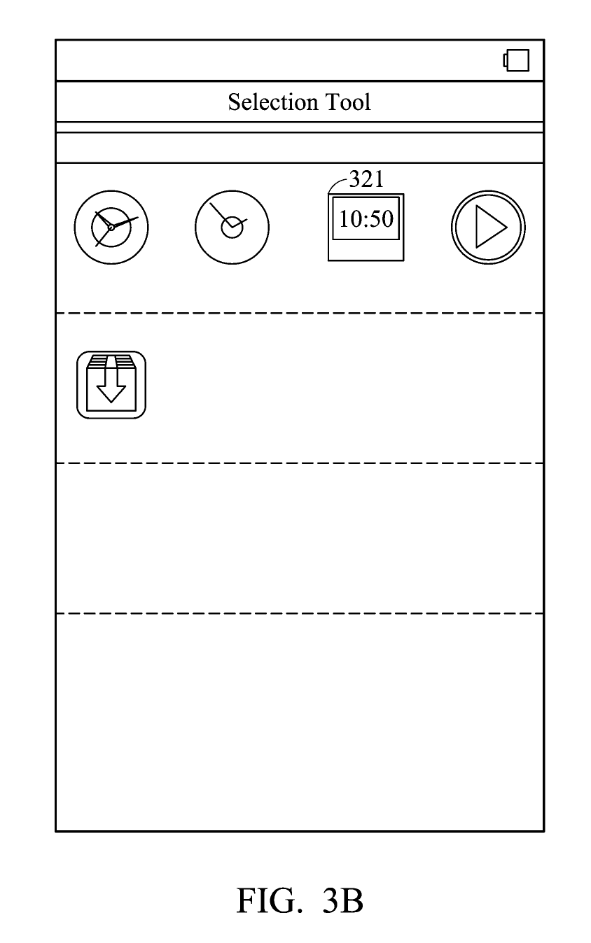

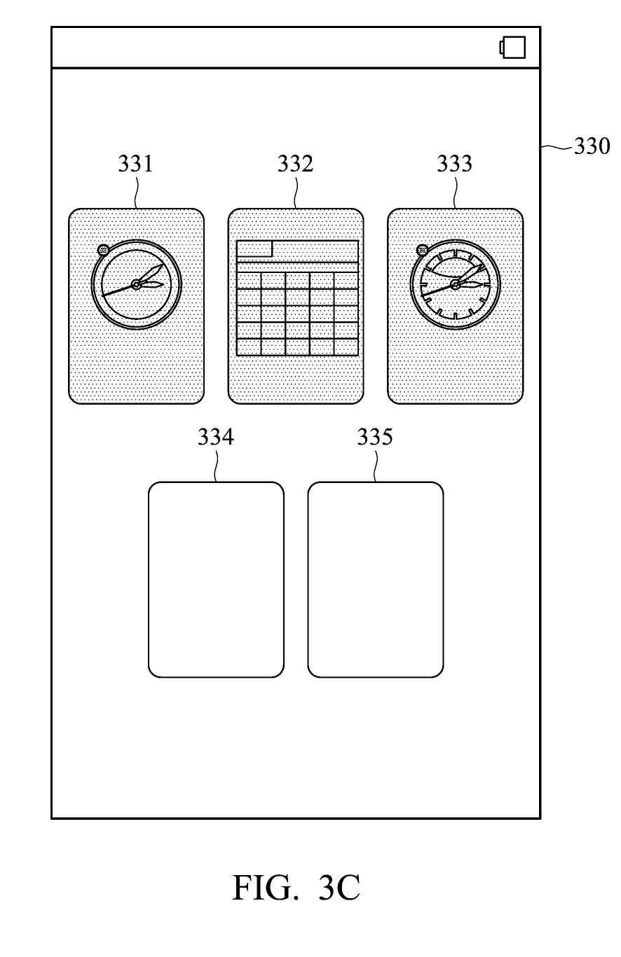

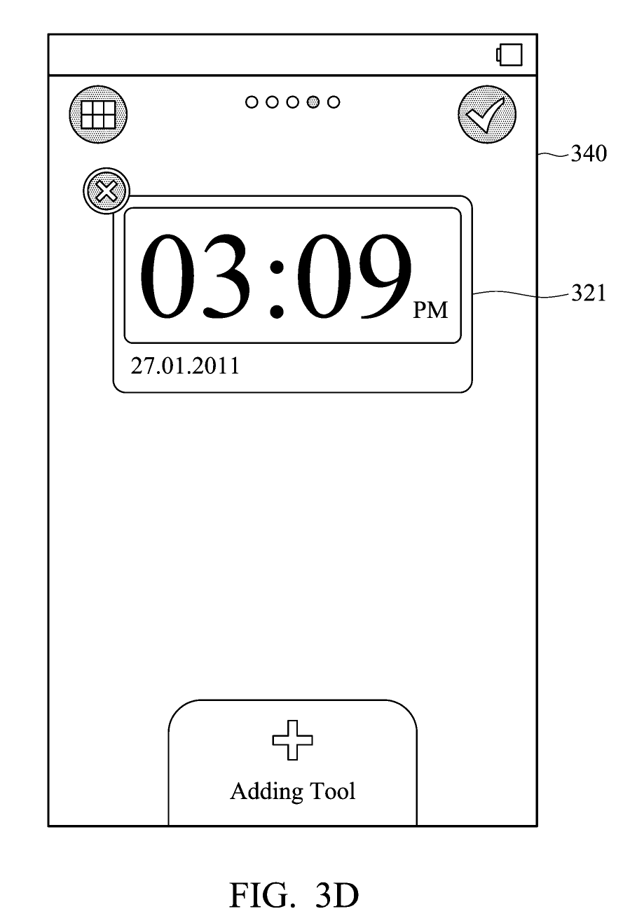

Referring to FIGS. 3A-3D, schematic diagrams of a series of steps for adding an item of an application program to a page of the screen 704 according to the invention are shown. In FIG. 3A, a current page 310 is shown on the screen 704. The current page 310 contains an item 302 of an analog clock program. The item 302 occupies a majority of the area of the current page 310. Assume that a user presses the adding tool application 302 at a certain location of the screen 704, in one embodiment of the invention, the adding tool application 302 could be located at the bottom of the screen 704, in another embodiment, the adding tool application 302 is located at other regions of the screen 704, a selection tool containing icons of a plurality of programs is then shown on the screen, as shown in FIG. 3B. Assume that the user selects the icon 321 of a digital clock program from the selection tool shown in FIG. 3B, an item 321 of the digital clock program is then to be added to one of a plurality of pages. The processor 702 first determines whether the current page 310 shown in FIG. 3A has enough space to contain the item 321. Because the old item 302 occupies a majority of the area of the current page 310, the current page 310 has no enough space for containing the item 321.

The processor 702 therefore displays a page selector 330 on the screen 704, as shown in FIG. 3C. The page selector 330 contains thumbnails 331˜335 of all five pages of the portable electronic apparatus 700. Three thumbnails 331, 332, and 333 have been filtered by a color filter. The pages corresponding to the thumbnails 331, 332, and 333 are therefore unavailable pages having no enough space for the item 321, and the pages corresponding to the thumbnails 334 and 335 are available pages. Assume that the user selects the thumbnail 334 according to the page selector 330, the page 340 corresponding to the thumbnail 334 is therefore shown on the screen 704, and the item 321 of the digital clock program is added to the page 340, as shown in FIG. 3D.

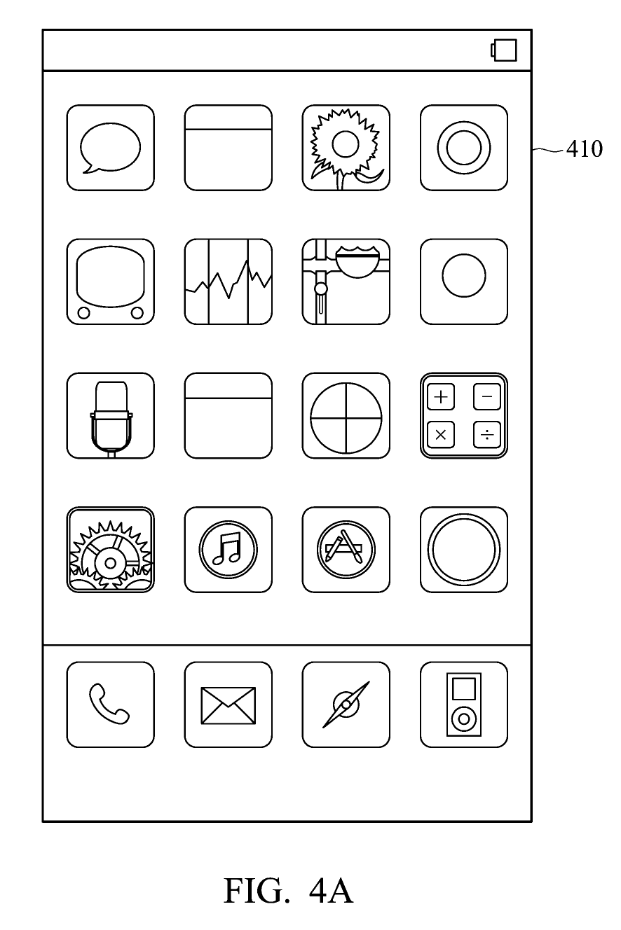

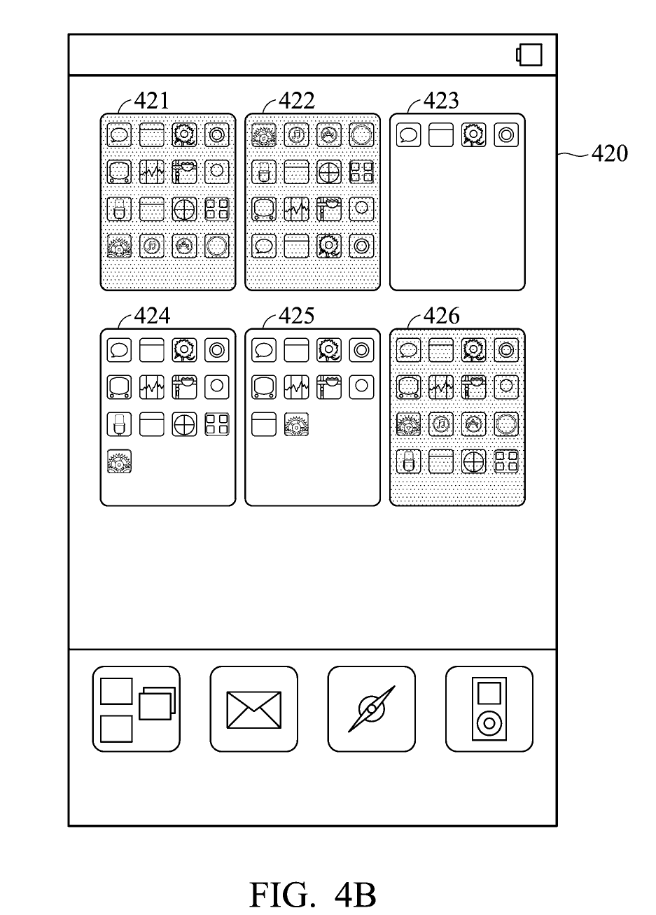

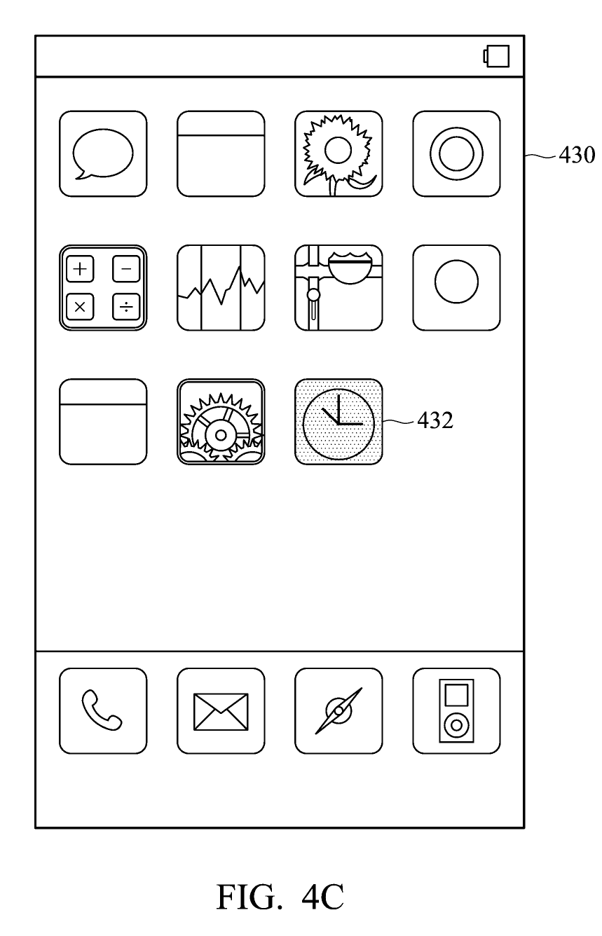

A program menu has a plurality of menu pages, wherein each menu page can be displayed on a screen and can contain a plurality of program icons for user selection. Each program icon represents an application program which can be executed on a portable electronic device. When a target program icon is selected by a user from a menu page, an application program corresponding to the target program icon is executed, and an item of the application program is shown on a current page of a screen of the portable electronic device. The page recommendation method 200 shown in FIG. 2B can also be applied in adding of program icons to menu pages. Referring to FIGS. 4A-4C, schematic diagrams of a series of steps of adding a new icon of an application program to a program menu according to the invention are shown. Assume that the program menu comprises six menu pages. Each of the menu pages can contain a plurality of program icons and can be independently displayed on the screen 704 of the portable electronic apparatus 700. Assume that a user wants to add a new icon of a clock program to the program menu. The processor 702 then determines whether a current menu page has enough space to contain the new icon of the clock program. The current menu page 410 shown in FIG. 4A, however, does not have enough space for the new icon. The processor 702 then displays a page selector 420 on the screen 704, as shown in FIG. 4B. The page selector 420 comprises thumbnails 421˜426 of all six menu pages of the program menu. The thumbnails 421, 422, and 426 have been filtered by a color filter to indicate that the corresponding menu pages are unavailable pages having no space for the new icon. Three menu pages corresponding to the thumbnails 423, 424, and 425 are available pages. Assume that the user selects the thumbnail 425. The processor 702 therefore adds the new icon 432 of the clock program to the menu page 430 corresponding to the selected thumbnail 425, as shown in FIG. 4C.

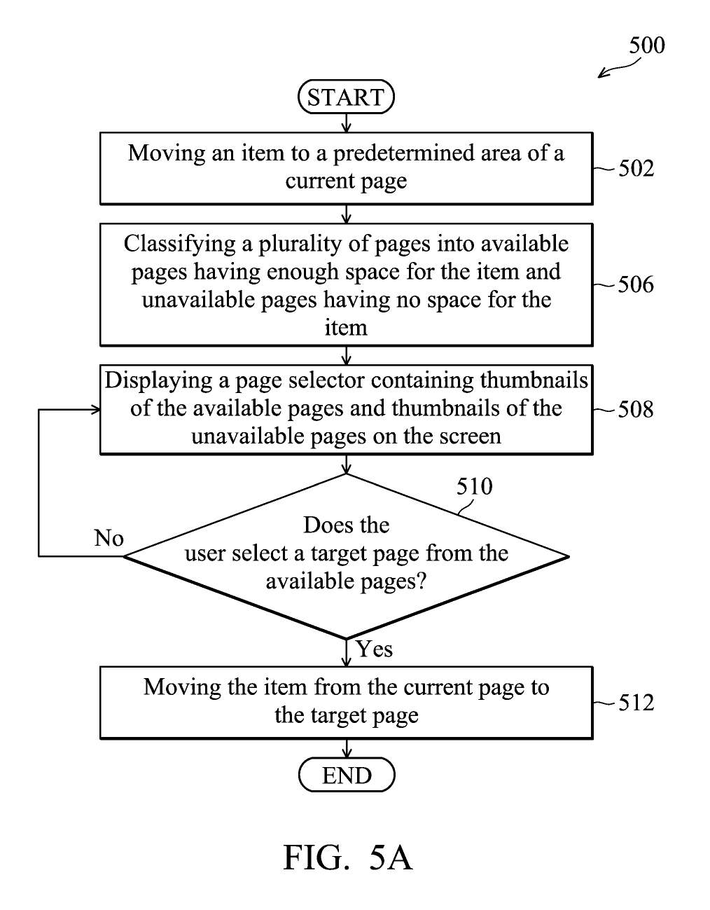

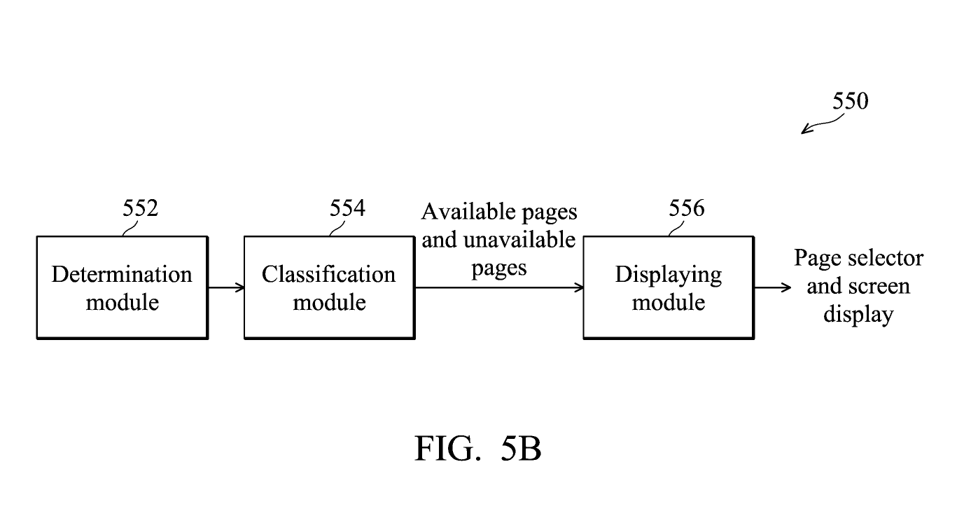

A user may want to move an item of an application program from a current page to a target page. The page selector 330 shown in FIG. 3C can also be used to recommend available pages having enough space for the item to the user. Referring to FIG. 5A, a flowchart of a method 500 for moving an item of an application program from a current page to a target page according to the invention is shown. First, the processor 702 determines whether the user moves an item to a predetermined region of the current page (step 502). In one embodiment, the item may be a widget, an object, or an application program. And in one embodiment, the processor 702 also determines whether the item has remained in the predetermined region for a time period longer than a threshold, wherein the threshold may be 0.5 s, 1 s, or 5 s. When the item is determined to be moved to the predetermined region of the current page (step 502), the processor 702 classifies a plurality of pages into available pages having enough space for containing the item and unavailable pages having no enough space for containing the item (step 506). The detailed process for page classification of step 506 is the same as that of the step 208 of method 200 shown in FIG. 2B.

After the pages are classified into available pages and unavailable page, the processor 702 then displays a page selector containing thumbnails of the available pages and thumbnails of the unavailable pages on the screen 704 (step 508). The page selector displays the thumbnails of the available pages and the thumbnails of the unavailable pages in different styles. In one embodiment, when the page selector is displayed on the screen 704, the thumbnails of the unavailable pages are filtered by a color filter, and the thumbnails of the available pages are not filtered by the color filter. The detailed process of the step 508 of displaying of the page selector is the same as that of the step 214 of the method 200 shown in FIG. 2B. The user can then select a target page from the available pages according to the page selector (step 510). In one embodiment, the user selects the target page by pressing or dragging the thumbnail of the target page shown in the page selector. The processor 702 then moves the item from the current page to the target page (step 512). In one embodiment, the processor 702 removes the item from the current page, and then adds the item to the target page.

Referring to FIG. 5B, a block diagram of a processor 550 of a portable electronic apparatus capable of page recommendation according to the invention is shown. In one embodiment, a chip of the processor 550 comprises a determination module 552, a classification module 554, and a displaying module 556. The determination module 552 first determines whether a target item has been moved to a predetermined region of a current page displayed on a screen (step 502). If so, the classification module 554 then classifies a plurality of pages into available pages having enough space for the target item and unavailable pages having no enough space for the target item (step 506). The displaying module 556 then displays a page selector containing thumbnails of the available pages and the unavailable pages on the screen (step 508), wherein the thumbnails of the available pages and the thumbnails of the unavailable pages are displayed in different styles in the page selector. After the user selects a target page according to the page selector, the displaying module 556 then moves the target item to the target page (step 512).

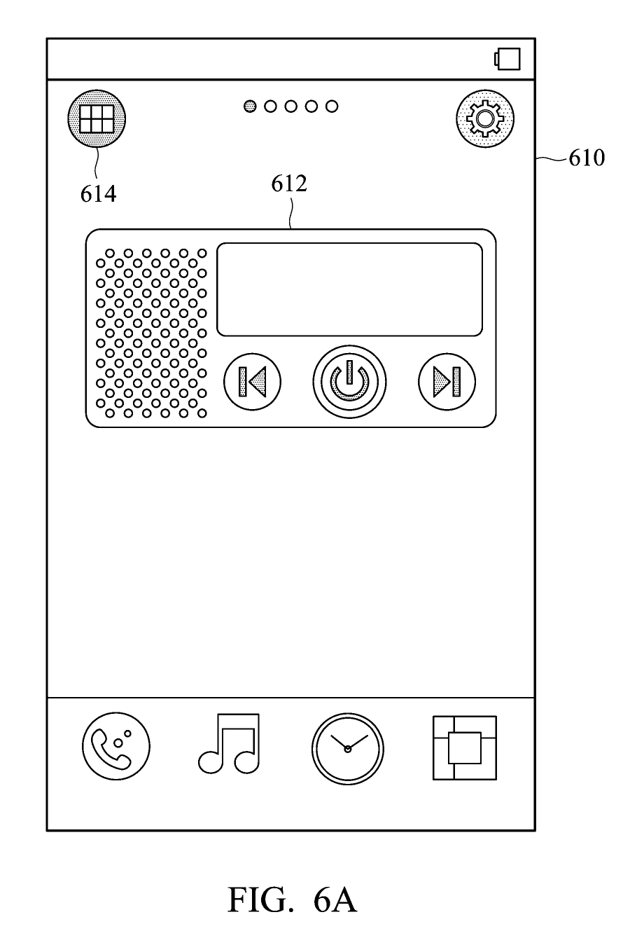

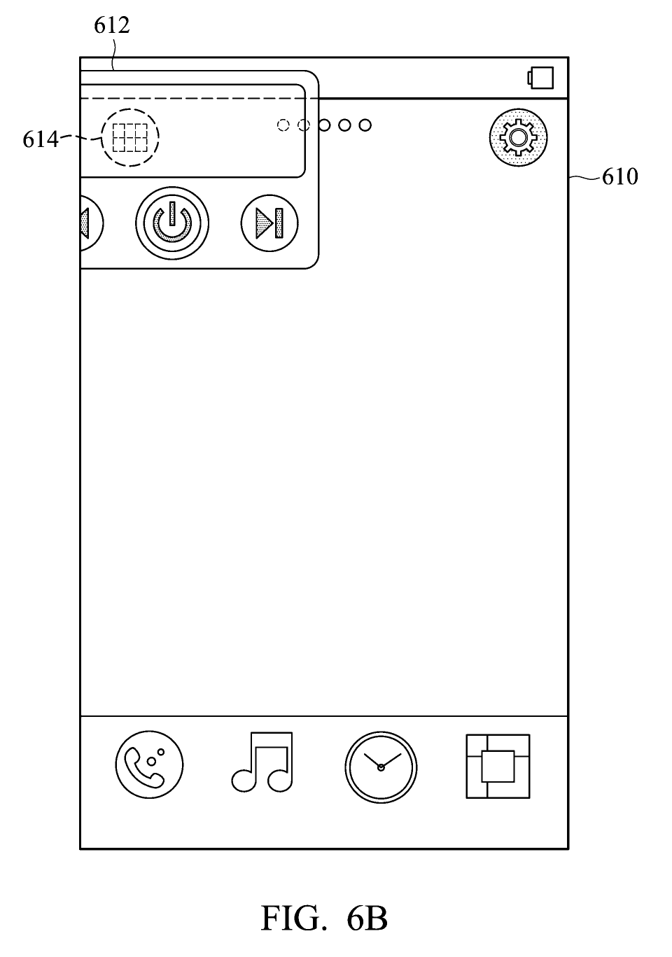

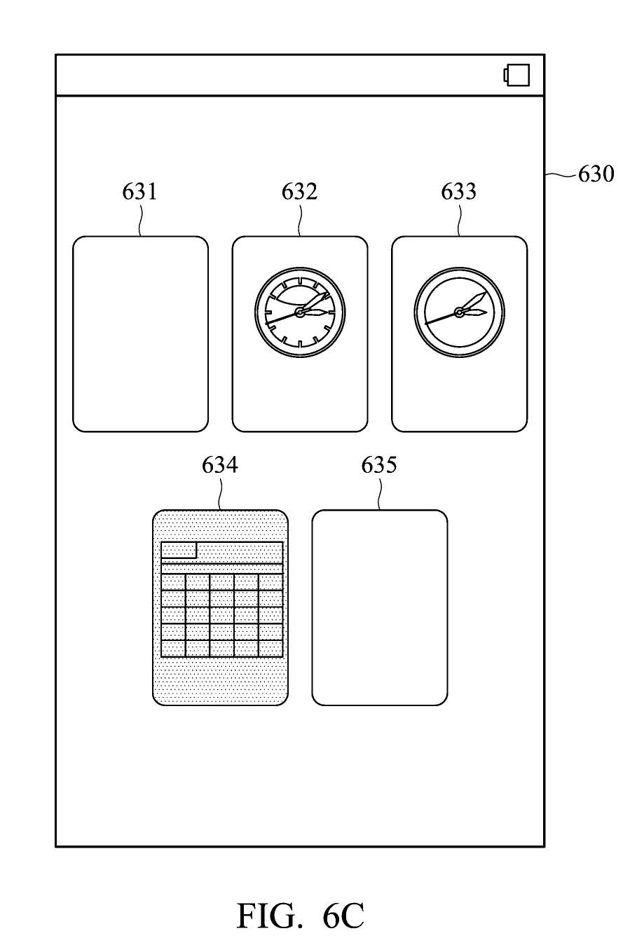

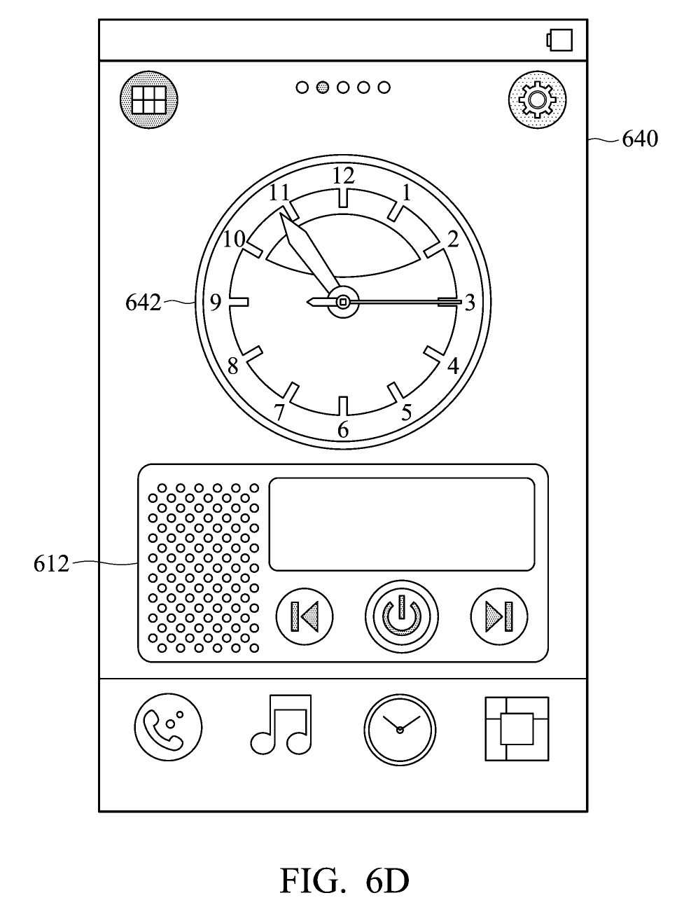

Referring to FIGS. 6A-6D, schematic diagrams of a series of steps of moving an item of an application program to a target page according to the invention are shown. In FIG. 6A, a current page 610 is shown on the screen 704. The current page 610 contains an item 612 of an audio player program. An icon 614 shown on a top-left corner of the current page 610 indicates a location of a predetermined region. The user then moves the item 612 to the predetermined region centered at the icon 614, as shown in FIG. 6B. When the item has been determined to be moved to the predetermined region, the processor 702 classifies the pages into available pages and unavailable pages, and displays a page selector 630 containing thumbnails of the available pages and thumbnails of unavailable pages on the screen 704, as shown in FIG. 6C. The page selector 630 contains thumbnails 631˜635 of all five pages of the portable electronic apparatus 700. The thumbnail 634 has been filtered by a color filter, and the page corresponding to the thumbnail 634 is therefore an unavailable page having no enough space for the item. The pages corresponding to the thumbnails 631, 632, 633, and 635 are available pages. Assume that the user selects the thumbnail 632 according to the page selector 630, the page 640 corresponding to the thumbnail 632 is therefore shown on the screen 704, and the item 612 of the audio player program is added to the page 640, as shown in FIG. 6D.

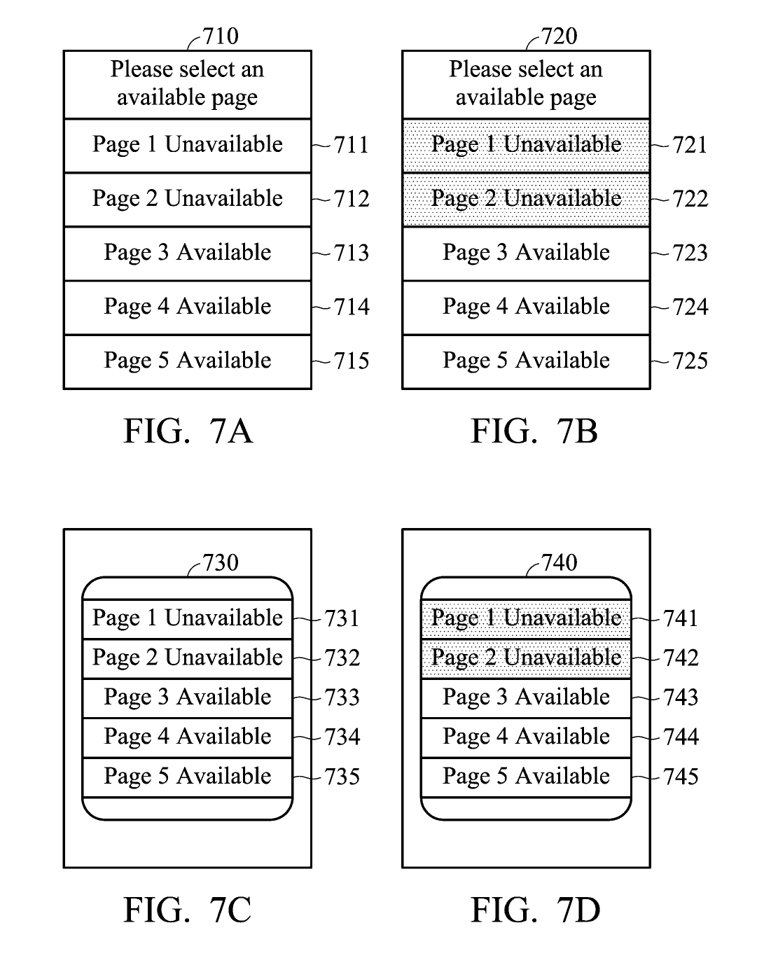

An embodiment of the page selector 330 shown in FIG. 3C contains thumbnails of all pages. The function of the page selector is to inform a user of whether the pages are available pages or unavailable pages as a reference for the user's selection. There are therefore also other embodiments of the page selector with different styles according to the invention. Referring to FIGS. 7A-7D, four embodiments 710, 720, 730, and 740 of the page selector with a style of a text list according to the invention are shown. The page selectors 710, 720, 730, and 740 contain a list of texts to respectively inform the user of whether pages 1, 2, 3, 4, and 5 are unavailable pages or available pages. For example, the list items 711, 721, 731, and 741 indicates that the page 1 is an unavailable page, the list items 712, 722, 732, and 742 indicates that the page 2 is an unavailable page, the list items 713, 723, 733, and 743 indicates that the page 3 is an available page, the list items 714, 724, 734, and 744 indicates that the page 4 is an available page, and the list items 715, 725, 735, and 745 indicates that the page 5 is an available page.

The page selector 710 and 720 shown in FIGS. 7A and 7B occupy the full area of the screen, and the page selector 730 and 740 shown in FIGS. 7C and 7D only occupy a majority of the area of the screen. In the page selectors 710 and 730 of FIGS. 7A and 7C, the list items of the unavailable pages 1 and 2 are shown with the same style with those of the list items of the available pages 3, 4, and 5. In the page selectors 720 and 740 of FIGS. 7B and 7D, the list items of the unavailable pages 1 and 2 are shown with a different style from those of the list items of the available pages 3, 4, and 5. In one embodiment, the list items of the unavailable pages 1 and 2 are shown with a different color from those of the list items of the available pages 3, 4, and 5. In another embodiment, the list items of the unavailable pages 1 and 2 are shown with a different frame style from those of the list items of the available pages 3, 4, and 5. In another embodiment, the shapes of the list items of the unavailable pages 1 and 2 are different from those of the list items of the available pages 3, 4, and 5. For example, the length and width of the list items of the unavailable pages 1 and 2 are different from those of the list items of the available pages 3, 4, and 5.

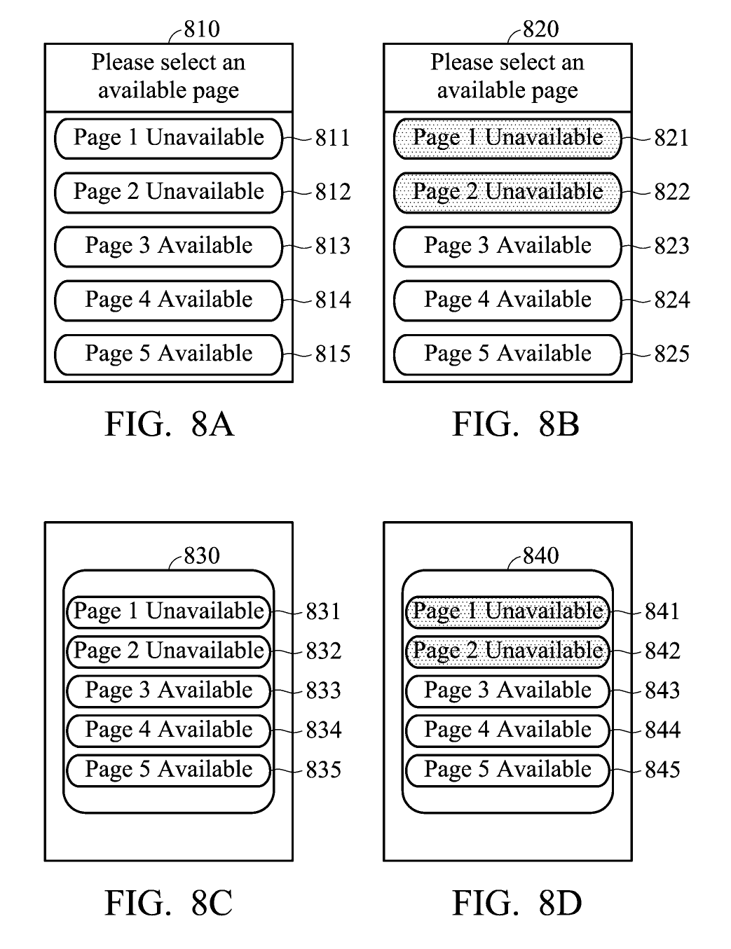

Referring to FIGS. 8A-8D, four embodiments 810, 820, 830, and 840 of the page selector with a style of a button list according to the invention are shown. The page selectors 810, 820, 830, and 840 contain a list of buttons to respectively inform the user of whether pages 1, 2, 3, 4, and 5 are unavailable pages or available pages. The user can therefore directly press the buttons of the pages in the page selector for selection. For example, the buttons 811, 821, 831, and 841 indicates that the page 1 is an unavailable page, the buttons 812, 822, 832, and 842 indicates that the page 2 is an unavailable page, the buttons 813, 823, 833, and 843 indicates that the page 3 is an available page, the buttons 814, 824, 834, and 844 indicates that the page 4 is an available page, and the buttons 815, 825, 835, and 845 indicates that the page 5 is an available page.

The page selector 810 and 820 shown in FIGS. 8A and 8B occupy the full area of the screen, and the page selector 830 and 840 shown in FIGS. 8C and 8D only occupy a majority of the area of the screen. In the page selectors 810 and 830 of FIGS. 8A and 8C, the buttons of the unavailable pages 1 and 2 are shown with the same style with those of the buttons of the available pages 3, 4, and 5. In the page selectors 820 and 840 of FIGS. 8B and 8D, the buttons of the unavailable pages 1 and 2 are shown with a different style from those of the buttons of the available pages 3, 4, and 5. In one embodiment, the buttons of the unavailable pages 1 and 2 are shown with a different color from those of the buttons of the available pages 3, 4, and 5. In another embodiment, the buttons of the unavailable pages 1 and 2 are shown with a different frame style from those of the buttons of the available pages 3, 4, and 5. In another embodiment, the shapes of the buttons of the unavailable pages 1 and 2 are different from those of the buttons of the available pages 3, 4, and 5. For example, the length and width of the buttons of the unavailable pages 1 and 2 are different from those of the buttons of the available pages 3, 4, and 5.

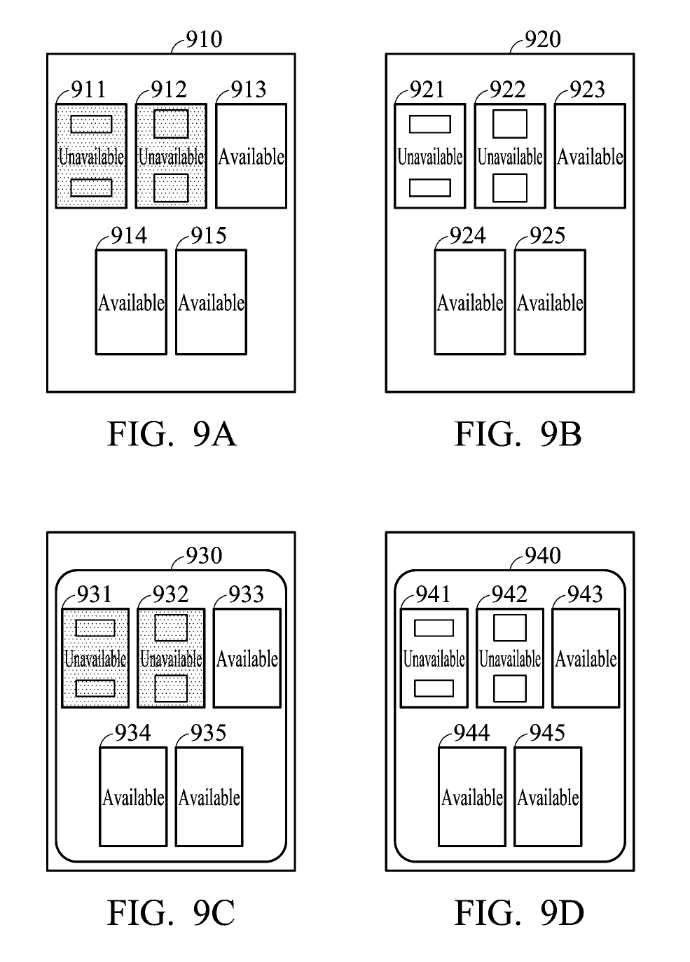

Referring to FIGS. 9A-9D, four embodiments 910, 920, 930, and 940 of the page selector with a style of a thumbnail list according to the invention are shown. The page selectors 910, 920, 930, and 940 contain a list of thumbnails to respectively inform the user of whether pages 1, 2, 3, 4, and 5 are unavailable pages or available pages. For example, the thumbnails 911, 921, 931, and 941 indicates that the page 1 is an unavailable page, the thumbnails 912, 922, 932, and 942 indicates that the page 2 is an unavailable page, the thumbnails 913, 923, 933, and 943 indicates that the page 3 is an available page, the thumbnails 914, 924, 934, and 944 indicates that the page 4 is an available page, and the thumbnails 915, 925, 935, and 945 indicates that the page 5 is an available page.

The page selector 910 and 920 shown in FIGS. 9A and 9B occupy the full area of the screen, and the page selector 930 and 940 shown in FIGS. 9C and 9D only occupy a majority of the area of the screen. In the page selectors 910 and 930 of FIGS. 9A and 9C, the thumbnails of the unavailable pages 1 and 2 are shown with the same style with those of the thumbnails of the available pages 3, 4, and 5. In the page selectors 920 and 940 of FIGS. 9B and 9D, the thumbnails of the unavailable pages 1 and 2 are shown with a different style from those of the thumbnails of the available pages 3, 4, and 5. In one embodiment, the thumbnails of the unavailable pages 1 and 2 are shown with a different color from those of the thumbnails of the available pages 3, 4, and 5. In another embodiment, the thumbnails of the unavailable pages 1 and 2 are shown with a different frame style from those of the thumbnails of the available pages 3, 4, and 5. In another embodiment, the shapes of the thumbnails of the unavailable pages 1 and 2 are different from those of the thumbnails of the available pages 3, 4, and 5. For example, the length and width of the thumbnails of the unavailable pages 1 and 2 are different from those of the thumbnails of the available pages 3, 4, and 5.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An apparatus capable of providing page recommendation, coupled to a screen capable of showing a plurality of pages, comprising:
a determination module, determining whether a current page displayed on the screen has enough space for containing a target item to be added to the current page;
a classification module, classifying the pages into available pages having enough space for the target item and unavailable pages having no enough space for the target item; and
a displaying module, displaying a page selector indicating the available pages and the unavailable pages on the screen, and adding the target item to a target page selected from the available pages.

2. The apparatus as claimed in claim 1, wherein the page selector contains thumbnails of the available pages and the unavailable pages, and the thumbnails of the available pages and the thumbnails of the unavailable pages are displayed in different styles in the page selector.

3. The apparatus as claimed in claim 1, wherein the page selector contains a list of text items representing the available pages and the unavailable pages, and the text items representing the available pages and the text items representing the unavailable pages are displayed in different styles in the page selector.

4. The apparatus as claimed in claim 1, wherein the page selector contains a list of buttons representing the available pages and the unavailable pages, and the buttons representing the available pages and the buttons representing the unavailable pages are displayed in different styles in the page selector.

5. An apparatus capable of providing page recommendation, coupled to a screen capable of showing a plurality of pages, comprising:
a determination module, determining whether a target item has been moved to a predetermined region of a current page displayed on the screen;
a classification module, classifying the pages into available pages having enough space for the target item and unavailable pages having no enough space for the target item when the target item has been moved to the predetermined region; and
a displaying module, displaying a page selector indicating the available pages and the unavailable pages on the screen, and moving the target item to a target page selected from the available pages.

6. The apparatus as claimed in claim 5, wherein the determination module, further determines whether the target item has remained in the predetermined region for a time period longer than a threshold.

7. The apparatus as claimed in claim 5, wherein the page selector contains thumbnails of the available pages and the unavailable pages, and the thumbnails of the available pages and the thumbnails of the unavailable pages are displayed in different styles in the page selector.

8. The apparatus as claimed in claim 5, wherein the page selector contains a list of text items representing the available pages and the unavailable pages, and the text items representing the available pages and the text items representing the unavailable pages are displayed in different styles in the page selector.

9. The apparatus as claimed in claim 5, wherein the page selector contains a list of buttons representing the available pages and the unavailable pages, and the buttons representing the available pages and the buttons representing the unavailable pages are displayed in different styles in the page selector.

10. A page recommendation method, comprising:
obtaining a target item to be added to a current page displayed on a screen capable of showing a plurality of pages;
determining whether the current page has enough space for containing the target item;
classifying the pages into available pages having enough space for the target item and unavailable pages having no enough space for the target item;
displaying a page selector indicating the available pages and the unavailable pages on the screen; and
adding the target item to a target page selected from the available pages.

11. The method as claimed in claim 10, wherein the page selector contains thumbnails of the available pages and the unavailable pages, and the thumbnails of the available pages and the thumbnails of the unavailable pages are displayed in different styles in the page selector.

12. The method as claimed in claim 10, wherein the page selector contains a list of text items representing the available pages and the unavailable pages, and the text items representing the available pages and the text items representing the unavailable pages are displayed in different styles in the page selector.

13. The method as claimed in claim 10, wherein the page selector contains a list of buttons representing the available pages and the unavailable pages, and the buttons representing the available pages and the buttons representing the unavailable pages are displayed in different styles in the page selector.

14. A page recommendation method, comprising:
determining whether a target item has been moved to a predetermined region of a current page displayed on a screen, wherein the screen is capable of showing a plurality of pages;
when the target item has been moved to the predetermined region, classifying the pages into available pages having enough space for the target item and unavailable pages having no enough space for the target item;
displaying a page selector indicating the available pages and the unavailable pages on the screen; and
moving the target item to the target page selected from the available pages.

15. The method as claimed in claim 14, further comprising:
determining whether the target item has remained in the predetermined region for a time period longer than a threshold.

16. The method as claimed in claim 14, wherein the page selector contains thumbnails of the available pages and the unavailable pages, and the thumbnails of the available pages and the thumbnails of the unavailable pages are displayed in different styles in the page selector.

17. The method as claimed in claim 14, wherein the page selector contains a list of text items representing the available pages and the unavailable pages, and the text items representing the available pages and the text items representing the unavailable pages are displayed in different styles in the page selector.

18. The method as claimed in claim 14, wherein the page selector contains a list of buttons representing the available pages and the unavailable pages, and the buttons representing the available pages and the buttons representing the unavailable pages are displayed in different styles in the page selector.
